(19) United States
(12) Patent Application Publication
(10) Pub. No.: US 2025/0200649 A1
(43) Pub. Date: Jun. 19, 2025

(54) TOOLS FOR ACCOUNT MANAGEMENT

(71) Applicant: Stripe, Inc., South San Francisco, CA (US)

(72) Inventors: Andrew STRAUSSMAN, Plymouth, MN (US); Ville-Jalmari KOSKELA, Redmond, WA (US); Maciej MAKOWSKI, Keswick (CA); Hyemin KIM, San Diego, CA (US); Maurice CLIFFORD, Killarney (IE); Etan Emanuel ZAPINSKY, Brooklyn, NY (US); Michael CHRISTMAN, Cardiff, CA (US)

(21) Appl. No.: 18/540,639

(22) Filed: Dec. 14, 2023

(51) Int. Cl. G06Q 40/02

(52) U.S. Cl. CPC G06Q 40/02

(57) ABSTRACT

Aspects of the subject technology include providing, from a sever to a first device, balance information for a plurality of accounts of an organization. For a first selected account, information for first expected sweeps which are to be received within a first time period, information for second expected sweeps for a second time period, and information for reconciled sweeps for the second time period are received. The first expected sweeps or the second expected sweeps include a first portion of expected sweeps which are automatically initiated by a service. When an anomaly is detected in the first account, the service may schedule an automated event to resolve the anomaly, and the automated event is reported. The service may not schedule an automated event and an input is received to resolve the anomaly.

### TECHNICAL FIELD

The present description generally relates to tools for managing accounts owned or controlled by an organization.

### BACKGROUND

Organizations may have many different accounts across different entities of the organization and in different countries. Management of such accounts can be complicated. For example, settlement times for transactions to or from accounts can vary by account type, location, time of transaction, or other factors. Moreover, when account activity occurs in a currency other than the primary currency of the organization, the organization can manage the risk that other currency may lose value. Inefficient management of such accounts can cause increased expense.

### BRIEF DESCRIPTION OF THE DRAWINGS

Certain features of the subject technology are set forth in the appended claims. However, for the purpose of explanation, several embodiments of the subject technology are set forth in the following figures.

FIG. 1 illustrates an example network environment in which the subject technology may be implemented, in accordance with one or more embodiments.

FIG. 2 depicts an example electronic device that may implement the subject technology, in accordance with one or more embodiments.

FIG. 3 depicts an example user interface for an account management service, in accordance with one or more embodiments.

FIG. 4 depicts an example user interface for sweeps transactions, in accordance with one or more embodiments.

FIG. 5 depicts an example interface for an FX tool, in accordance with one or more embodiments.

FIG. 6 depicts a flow diagram of an example process for managing a cash sweep, in accordance with one or more embodiments.

FIG. 7 depicts a flow diagram of an example process for managing a FX hedge, in accordance with one or more embodiments.

FIG. 8 depicts an example electronic system with which aspects of the present disclosure may be implemented, in accordance with one or more embodiments.

### DETAILED DESCRIPTION

The detailed description set forth below is intended as a description of various configurations of the subject technology and is not intended to represent the only configurations in which the subject technology can be practiced. The appended drawings are incorporated herein and constitute a part of the detailed description. The detailed description includes specific details for the purpose of providing a thorough understanding of the subject technology. However, the subject technology is not limited to the specific details set forth herein and can be practiced using one or more other embodiments. In one or more embodiments, structures and components are shown in block diagram form in order to avoid obscuring the concepts of the subject technology.

Large organizations may be made of many individual entities, each with their own financial systems. Entities may be organized by country of incorporation, country of operation, business function, product lines, and so forth. Many of such organizations may choose to let each entity or groups of entities operate financially independently. As such, the financial health of the entire organization is dependent on the proper care and management of each individual entity. Some organizations may have a central treasury that monitors and controls the cash and investments across multiple entities. While central control can provide a holistic approach to the cash and investment assets and obligations of the organization, it can be difficult for one treasury to effectively manage all of the assets and obligations of the organization while maintaining regulatory compliance across entities.

Implementations of the present disclosure provide administrative tools for treasury finance teams to monitor and manage an organization's financial operations. Rather than each legal entity of the organization maintaining a bilateral relationship with every other entity and/or each legal entity operating in a silo, the treasury sits in the middle (between organization entities and payors and payees) and consolidates transactions and manages assets and investments. The transactions are payments from and to the entity which are to be settled on varying settlement terms. Central consolidation and effective management may improve efficiency. Implementations provide administrative tools for treasury finance teams so that humans can monitor automated processes and intervene as needed.

The treasury tooling system includes, for example, observability into cash sweeps, observability into inter-company balances (e.g., inter-company liabilities), observability into cash positions (e.g., past/present/future cash positions), alerting, and foreign exchange risk management, which are briefly described below.

A cash sweep in this context is the movement of cash from one or more accounts account to another account when the accounts are under the control of the same entity. The accounts may be owned by the same legal entity or in some cases may be owned by different legal entities which are controlled at least in part by or by permission of a parent entity. Cash may be moved for any number of reasons. For example, cash may be moved to satisfy a regulatory requirement when a balance in one particular account is expected to go below a certain required threshold. Cash may be moved to satisfy an expected influx of transactions based on a known upcoming event. Cash may be moved to divest an over funded account into a higher interest bearing account. Cash may be moved from an investment account to another account to satisfy an expected liability. An automatic sweeps system of a cash flow management service monitors the various accounts and schedules automatic cash sweeps from and to accounts to address these or other transfers of cash.

Cash sweep observability in the treasury tools system provides monitoring and analysis of the automated movements of cash between different accounts. Cash sweep observability provides real-time insights into each cash sweep transaction, detailing amounts, source and destination accounts, and the triggers for these movements. Users can obtain detailed information regarding the underlying decision-making for the automated cash sweep and may alter, cancel, or reverse a cash sweep transaction and report the automated transaction. Utilization of the subject technology results in a reduction of network resources, computing resources, power, and memory. For example, accurate balance management results in fewer sweeps between accounts through better planning and forecasting.

Inter-company balance observability deals with monitoring the financial interactions and balances between different legal entities of the same company. Inter-company balance observability aids in risk management by identifying potential issues arising from cross-border flows and intercompany netting. Visibility into the financial standings of each legal entity is provided, ensuring that inter-company transactions are balanced, and any imbalances are quickly identified and addressed. Inter-company balance observability helps in maintaining financial equilibrium across different legal entities, ensuring compliance with internal policies and external regulations. While it also receives data from automatic sweeps system for transactions it handles, it is more broadly integrated with the company's accounting systems and financial databases to provide a comprehensive view of all inter-company transactions and balances. The provided Inter-company balance observability of the subject technology results in a reduction of network resources, computing resources, power, and memory. For example, providing balance information at a central location results in fewer overall balance requests, utilizing less power and network resources.

Cash position observability deals with monitoring of current, historical, and forecasted/predicted cash balances across all the bank accounts of the organization. Effective liquidity management is obtained by providing a clear view of each entity's available funds, past cash flow trends, and future cash position forecasts/predictions. Cash position observability offers a holistic view of an entity's liquidity, enabling administrative users, e.g., managers, to proactively manage funds, anticipate potential liquidity challenges, and optimize cash utilization. The provided cash position observability of the subject technology results in a reduction of network resources, computing resources, power, and memory. For example, accurate balance management results in fewer sweeps between accounts through planning and forecasting.

Alerting aggregates alerts generated by various financial systems, including the automatic sweeps system, providing a comprehensive yet contextual view of all notifications in one place. Rather than manually checking every transaction, automated alerts can monitor accounts against a set of rules and provide alerts to administrative users for manually handling as needed. An alerting process continuously monitors data feeds from the connected systems, analyzing the incoming data against predefined rules and criteria to detect any deviations or anomalies. Once an anomaly or threshold breach is detected, an alert is generated and displayed on the dashboard in real-time, allowing prompt response to potential issues. Some alerts can trigger a pause in transactions or sweeps between certain accounts. Such alerts notice an emergency situation and provide an emergency control to pause activity in one or more accounts until verification is received from a human manager that the emergency situation was resolved or determined to be within normal parameters. The provided alerting functions of the subject technology results in a reduction of network resources, computing resources, power, and memory. For example, alerting provides less utilization of network resources and computing resources by proactively providing information to administrative users, such as account managers, rather than having administrative users querying multiple sources to try to accumulate necessary data on their own to make such determinations.

Foreign currency (FX) tooling provides centralized management and oversight of foreign currency exchange operations and risks within the organization. FX tooling can facilitate identifying natural hedges, aggregating, and netting FX exposure, as well as conducting internal FX trading to trade away exposure as necessary to keep FX risk below a predetermined threshold. The provided FX tooling functions of the subject technology results in a reduction of network resources, computing resources, power, and memory. For example, the FX tooling functions provides less utilization of network resources and computing resources by consolidating FX hedge positions across multiple transactions to avoid unnecessary transactions to close and/or open positions unnecessarily.

Aspects of the subject technology include both backend processes and a frontend interface for administrative users to access treasury tools. The backend processes aggregate data from multiple account server sources and analyze the data for conditions. The frontend interface can present users with informative data and allow the user to interact with the data. With the subject technology, users may use a graphical user interface to observe cash sweeps and obtain information underlying the reasons for automated cash sweeps, alter automatic cash sweeps, create manual cash sweeps, observe balances across legal entities, observe cash positions for current, historical, and expected future cash balances, receive and process alerts, and interface with FX tooling. Automating the management of these processes provides more efficient outcome and cost-savings. Not only is necessary manpower reduced, but effective management results in fewer transaction fees, lower transaction fees, and higher balances in higher interest accounts. Utilization of the subject technology also further results in a reduction of network resources, computing resources, power, and memory. For example, consolidating and providing effective management results in fewer calls from individual users to various account server sources since these are consolidated. Further, fewer transactions are realized through effective management.

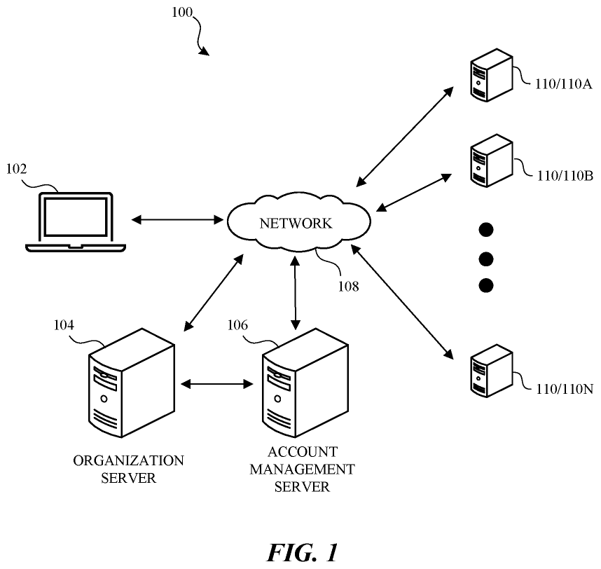

FIG. 1 illustrates an example network environment 100 in which the subject technology may be implemented, in accordance with one or more embodiments. Not all of the depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The network environment 100 may include an electronic device 102, an organization server 104, an account management server 106, and financial institution servers 110, such as a first server 110A, a second server 110B, and so on until the Nth server 110N. The financial institution servers 110 may be owned, operated, or controlled by one or more financial institutions, such as banks. Each of these servers 110 may be associated with one or more accounts of the organization and can provide information for the accounts of the organization to the organization server 104 and/or the account management server 106. The network 108 may communicatively (directly or indirectly) couple one or more of the electronic device 102, the organization server 104, and the account management server 106, and the financial institution servers 110. In one or more embodiments, the network 108 may be an interconnected network of devices that may include, or may be communicatively coupled to, the internet. The organization server 104 may be communicatively connected to the account management server 106 via a private connection as well, as indicated in FIG. 1.

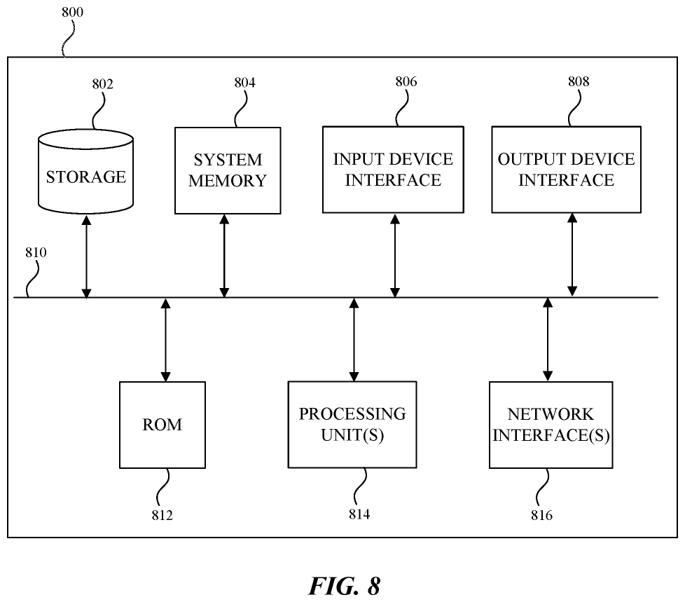

For explanatory purposes, the network environment 100 is illustrated in FIG. 1 as including the electronic device 102, the organization server 104, and the account management server 106; however, the network environment 100 may include any number of electronic devices and/or any number of servers communicatively coupled to each other directly or via the network 108. In addition, the various systems of FIG. 1 may be, and/or may include all or part of, the electronic system discussed below with respect to FIG. 8.

The electronic device 102 may be under the control of a user that is internal to the organization or operating under the authorization of the organization in an administrative capacity, e.g., and administrative user. Thus, the electronic device 102 is used to access the administrative tools described herein. The electronic device 102 may be, for example, a wearable device (such as a watch, a band, and the like), a desktop computer, a portable computing device (e.g., a laptop computer), a smartphone, a peripheral device (e.g., a digital camera, headphones), a tablet device, or any other appropriate device that includes, for example, one or more wireless interfaces, such as WLAN radios, cellular radios, Bluetooth radios, Zigbee radios, near field communication (NFC) radios, and/or other wireless radios. In FIG. 1, by way of example, the electronic device 102 is depicted as a laptop computer. The electronic device 102 may be associated with one or more accounts, credentials, or any other identity information registered with the organization server 104 and/or the account management server 106 belonging to a user associated with the electronic device 102.

The organization server 104 may be and/or may include, for example, one or more servers that host or facilitate a service that may be used by one or more entities (e.g., the electronic device 102). For example, the organization server 104 may belong to a payment processor, and the service may include an account management service that can provide account management across each of the accounts associated with the financial institution servers 110. Account management can include payment processing, a liquidity service that provides automatic cash sweeps between accounts, an FX service that provides automatic risk management for foreign transactions, and an alert service that monitors account balances for accounts located at the financial institution servers 110 and generates alerts or emergency alerts when an anomaly is detected. The organization server 104 may store account information (e.g., user account, usernames/handles, or any other account-specific data) associated with the electronic device 102 and/or users thereof and/or users associated therewith. The organization server 104 may be, and/or may include all or part of, the electronic system discussed below with respect to FIG. 8.

The account management server 106 may be and/or may include, for example, one or more servers that host or facilitate a service that may be used by one or more entities (e.g., the electronic device 102). For example, the account management server 106 may belong to the organization and may provide aspects of the subject technology, such as tools for viewing account information, providing expected future balances, managing cash sweeps, providing alerts, and providing FX information. The account management server 106 may store account information (e.g., administrative user account, usernames/handles, or any other account-specific data) associated with the electronic device 102 and/or users thereof and/or users associated therewith. The account management server 106 may be, and/or may include all or part of, the electronic system discussed below with respect to FIG. 8.

The organization server 104 processes payment transactions at various merchants or vendors (not shown) by their customers (not shown). For example, when a customer presents a credit card at a merchant to pay for goods or services a payment is processed at the point of sale by way of the organization server 104, resulting in transactions with the card issuer (e.g., bank), the merchant or vendor, and the card payment company (e.g., Visa™, Mastercard™, etc.) (which may be the same company in some instances). The payment transactions result in the creation of a liability to pay the merchant and an asset to receive money from the card issuer. These transactions take some time to settle. Settlement times may be based in part on negotiated terms negotiated with the various entities involved in the transaction and in part on the time the banking system takes to process the transfer of funds. The banking system settlement time may be dependent on the jurisdictions which are involved. For example, some banking systems in some jurisdictions may intentionally slow transaction settlements as a rough backstop for fraud prevention or to accommodate antiquated institutions.

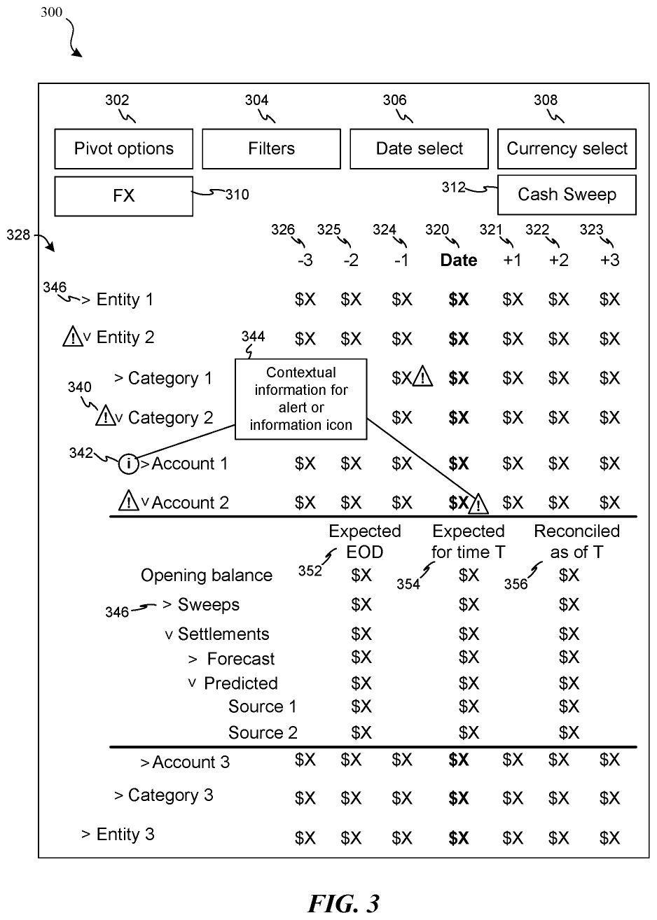

While these payment transactions necessarily trigger any number of events from the entities involved, aspects of the subject technology are concerned with tracking these payment transactions, including past, current, and future (expected) transactions, and automatically adjusting account balances (e.g., using cash sweeps) as needed to remain solvent across all accounts, as is discussed further below with respect to FIGS. 3, 4, and 6.

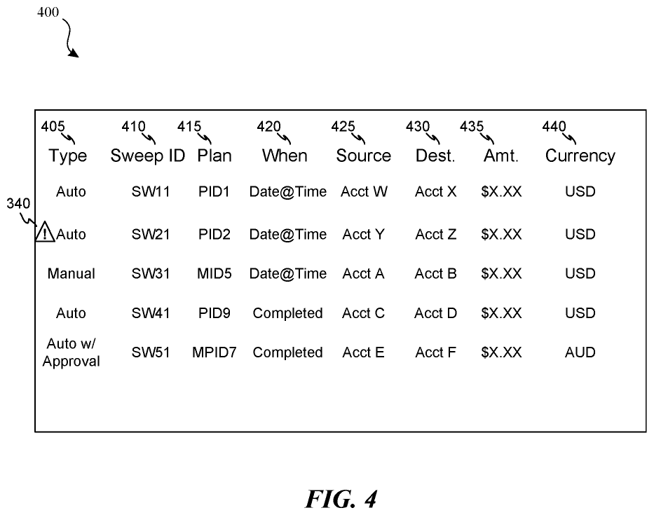

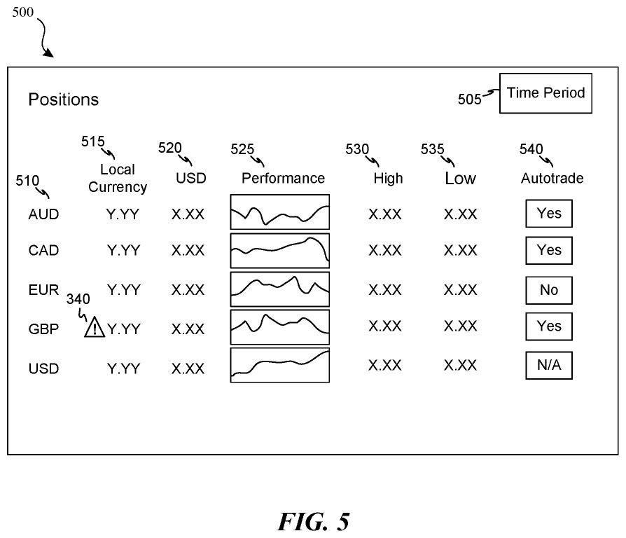

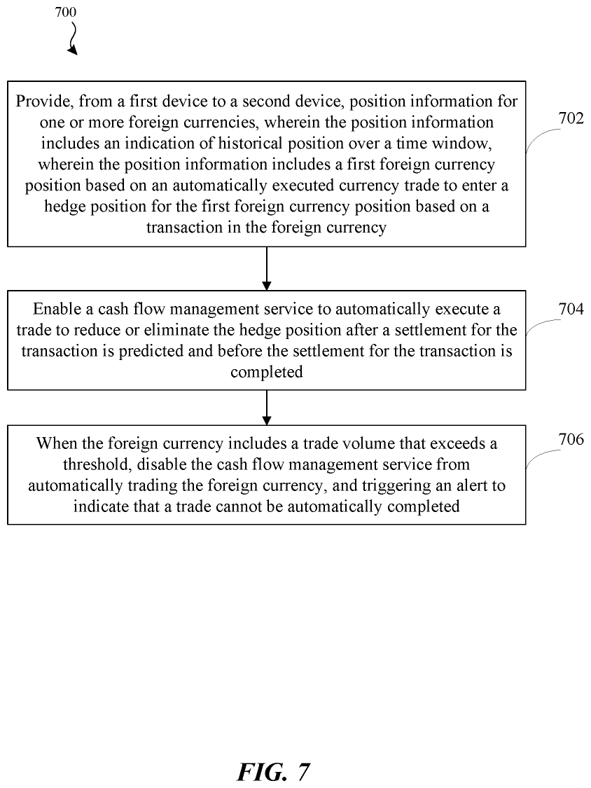

The subject technology provides users with various user interface tools for managing account positions, account sweeps, and alerts or information indicators related thereto. The user interface tools may include being able to view automatic cash sweeps, adjust automatic cash sweeps, and provide manually entered cash sweeps, as is discussed further below with respect to FIGS. 3 and 4. The user interface tools may also include tools to provide an advance balance sheet that provides historical balance information, current balance information, and future (expected) balance information, which can be displayed in aggregated or individual account form, as is discussed below with respect to FIG. 3. An interface may also be provided for users to view intraday information for an account, an opening balance, a balance at a particular time in the day, past or future, a current balance, and expected balance at end of day (EOD), as is discussed below with respect to FIG. 3. The user interface tools may further include the ability to utilize all of these account and cash sweep inputs and provide an alerting system and emergency intervention system that provides alerts to users through an interface so that users can take manual intervention as needed when an anomalous condition occurs, as is discussed below with respect to FIGS. 3 and 4. A user interface may also be provided with tools to provide insights into a FX platform for transactions between different currency pairs and automatic hedging that accompanies these transactions, as is discussed below with respect to FIGS. 5 and 7.

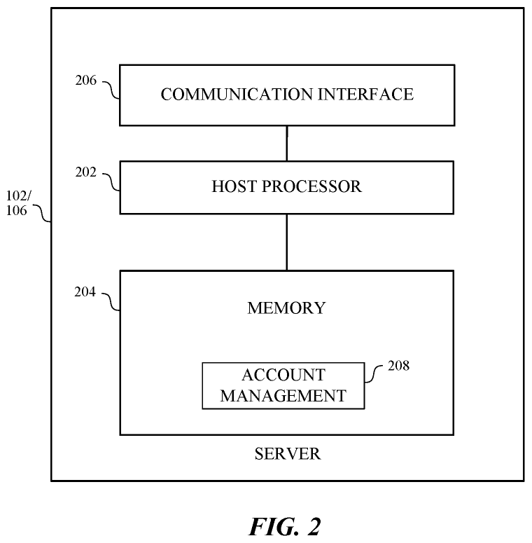

FIG. 2 depicts an example electronic device 102 or account management server 106 that may implement the subject technology, in accordance with one or more embodiments. For explanatory purposes, FIG. 2 is primarily described herein with reference to the electronic device 102 or account management server 106 of FIG. 1. However, this is merely illustrative, and features of the server of FIG. 2 may be implemented in any other electronic device for implementing the subject technology. Not all of the depicted components may be used in all embodiments, however, and one or more embodiments may include additional or different components than those shown in FIG. 2. Variations in the arrangement and type of the components may be made without departing from the spirit or scope of the claims as set forth herein. Additional components, different components, or fewer components may be provided.

The electronic device 102 or account management server 106 may include one or more of a host processor 202, a memory 204, and/or a communication interface 206. The host processor 202 may include suitable logic, circuitry, and/or code that enable processing data and/or controlling operations of the electronic device 102 or account management server 106. In this regard, the host processor 202 may be enabled to provide control signals to various other components of the electronic device 102 or account management server 106. The host processor 202 may also control transfers of data between various portions of the electronic device 102 or account management server 106. The host processor 202 may further implement an operating system or may otherwise execute code to manage operations of the electronic device 102 or account management server 106.

The memory 204 may include suitable logic, circuitry, and/or code that enable storage of various types of information such as received data, generated data, code, and/or configuration information. The memory 204 may include volatile memory (e.g., random access memory (RAM)) and/or non-volatile memory (e.g., read-only memory (ROM), flash, and/or magnetic storage). In the case of the account management server 106, the memory 204 may include account management 208 including executable programs, routines, and services that provide the functions described herein.

The communication interface 206 may include suitable logic, circuitry, and/or code that enables wired or wireless communication, such as between the electronic device 102, the organization server 104, the account management server 106, and/or financial institution servers 110. The communication interface 206 may include, for example, one or more of a Bluetooth communication interface, an NFC interface, a Zigbee communication interface, a WLAN communication interface, a USB communication interface, a cellular interface, or generally any communication interface.

In one or more embodiments, one or more of the host processor 202, the memory 204, the communication interface 206, and/or one or more portions thereof may be implemented in software (e.g., subroutines and code), may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both.

FIG. 3 illustrates an example interface 300 for displaying and managing account information and alerts for the account information, in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The account management server 106 may generate and/or provide a user interface, such as the user interface 300, for displaying and managing the above-noted aspects of the subject technology. The user interface 300 can provide information, for example, related to aspects of the subject technology that provide account information for multiple accounts of an organization. The user interface 300 includes the ability for a user to view accounts from multiple entities in a selected currency and historic and expected future balances in a single view. The user interface 300 allows the user to view cash sweeps information for one or more accounts. The user interface 300 also provides contextual alert information and other contextual information through the use of alert indicators and information indicators that the user can interact with via the user interface 300.

The user interface 300 may be interactive, minimizing the need for coding or technical expertise. The user interface 300 may be graphical, providing users with a visual canvas where they can interact with and manage account information using a variety of graphical elements (e.g., buttons, checkboxes, dropdowns, icons, pop-outs, input fields, breadcrumbs, etc.). The user interface 300 offers a centralized location for administrative users, e.g., managers, to view and manage account information, balances, cash sweeps, and alerts. The centralized nature of the subject technology and interface thereto may reduce the number of requests that a merchant needs to send to the server to manage the account cash positions, thereby reducing the processing, memory, and/or communication resources needed to manage such cash positions.

As shown in FIG. 3, the user interface 300 may provide pivot options 302, filters 304, date select 306, and currency select 308. Pivot options 302 provide the ability to customize the organization of each of the levels of the pivot table 328 below by selecting pivot entries on which to organize the pivot table. Pivot options 302 may allow the user to select the pivot entry for the organization of the first pivot level as being entity, type, currency, bank partner, domicile country, country of account location, or a customized tag. Pivot options 302 may allow the user to select the pivot entry for the organization for a second level of the pivot table 328 from the options remaining after the first level. Pivot options 302 may allow the user to select a pivot entry for the organization for a third level of the pivot table 328 from the options remaining after the second level. Pivot options 302 may allow the user to select a pivot entry for the organization for a fourth level, fifth level, and so forth in like manner. In the illustrated example, the first pivot entry is on entities (e.g., Entity 1, Entity 2, Entity 3, etc.) and a second pivot entry is on type or category (e.g., Category 1, Category 2, Category 3, etc.). Accounts are organized under the second pivot entry. A third pivot entry could be currency, for example, and accounts could be organized under the third pivot entry. Another pivot entry could be “responsible manager,” and administrative users can organize the pivot table based on their organization assigned role.

Filters 304 may provide filters to include only wanted data or exclude unwanted data. For example, if a particular user is tagged on an entity, then filtering on that user may include or exclude any entities where that user is tagged. Filters can also include partner bank names, card processor names, IDs, descriptions, currency types, status, alert conditions, and so forth. The date select 306 can provide the target date for the target date column 320 of the pivot table 328. The next three days after the target date, e.g., the date +1 column 321, the date +2 column 322, and the date +3 column 323 can be provided to the right of the target date column 320. The previous three days before the target date, e.g., the date −1 column 324, the date −2 column 325, and the date −3 column 326 can be provided to the left of the target date column 320. Each of these columns contains aggregated values for a corresponding row entry of the pivot table 328. The currency select 308 can provide the values in the pivot table 328 in a customized currency.

Thus, the date columns can display current and/or historical aggregated balances which are aggregated according to the applicable pivot entry. In addition, the date columns can display future expected aggregated balances, where the future expected balances are determined using processes as described in further detail below. According to some implementations, if the target date selected would cause the date +1 column 321, date +2 column 322, or the date +3 column 323 to be future dates, then those aggregated expected future balances can be displayed in the respective columns.

Because the pivot table can be customized by selecting the pivots for the top level and each of the sub-levels of the pivot table, the account manager can conveniently customize the view of the pivot table to obtain relevant information at each pivot level. For example, the first pivot can be specified to pivot on “country of account location.” In the resulting pivot table, each of the first levels of the table can correspond to each of the countries where accounts are located. The columns corresponding to each country of account location can display aggregated values combining the values for each of the accounts so that the account manager can view the total balance in each country. The currency select function, for example provided by the currency select 308, can provide the ability to choose to display the aggregated values in their native currency or in a specified currency. Details for each of the accounts can be accessed by expanding the pivot entry by selecting the expansion indicator 346.

The cash sweep button 312 and the FX button 310 can take the user to a new screen for cash sweep tools and FX tools, as respectively described below with respect to FIGS. 4 and 5.

As noted above, each of the rows of the pivot table 328 can be custom organized. In the illustrated example, the first pivot is on entity so that the first level of the pivot table is organized by entity, such as Entity 1, Entity 2, Entity 3, and so forth. The columns to the right of each entity pivot entry can provide aggregated totals for each entity. A second pivot is on type or category so that the second level of the pivot table is organized by type or category, such as Category 1, Category 2, Category 3, and so forth. The columns to the right of each category can provided aggregated totals for each category under the specified entity. This view can provide an inter-company balance view to provide information for account balances across multiple entities of the organization. Entity 1 can refer to a legal entity which may be a subsidiary, for example, of the organization. The scope of subsequent actions can be automatically limited based on the pivot table organization. For example, organizing by entities, such as Entity 1, can automatically limit the scope of subsequent actions to those entities. For example, if the user selects Account 1 under Category 2 of Entity 2, an option may appear to perform a cash sweep. The configuration options for action can be contextually scoped to the available accounts for the cash sweep to show by default only those accounts under the same entity and under the same category, e.g., Entity 2 and Category 2 in this example. In the interface for the subsequent action, the user can alter the contextual scope to expand the scope to show accounts from other categories under the same entity or may further expand the scope to show accounts from other entities.

The user interface 300 may also include an alert indicator 340, an information indicator 342, a contextual information box 344, and various expansion indicators 346. The user may select an alert indicator 340, for example, which can display and populate the contextual information box 344 with relevant information for the alert indicator 340 selected. The information indicator 342 may be selected and contextual information displayed in like manner. A link may be provided in the contextual information box 344 which takes the user to another page with further detail and suggested actions to be taken, as further explained in detail below. A user may select an expansion indicator 346 to expand the row to display the next sub-pivot or select the expansion indicator 346 to collapse the row to hide the next sub-pivot.

The user interface 300 can also include a cash positions section which can be displayed for each of the accounts when the expansion indicator 346 is selected for an account. The cash positions section includes a balance expected at a predetermined time period, such as the end of day (EOD 352), e.g., at 5:00 PM EST, or some other standard and/or pre-configured time, a balance expected at a particular, e.g., pre-configured, time of day (time T 354), e.g., the current time or another specified time, and a reconciled balance at a particular time of day (reconciled T 356), e.g., the current time or another specified time (which may or may not be the same time as the time used for time T 354).

The cash positions section can provide the balances for each of the expected EOD 352, time T 354, and reconciled T 356 for each of an opening balance, sweeps, and settlements. The current intraday bank account balances, historical settlement data, and expected future balances (end of day, end of day+1 day, +2 days, +3 days, etc.) are provided. The expected future balances are driven by predicted account changes and forecasted account changes.

Predicted account changes are expected account changes based on known but unavailable income or expenditures. For example, when an obligation is created, but not yet due, the future balance will be lowered by the predicted change. If the obligation is cancelled for some reason, then the account will not be lowered. In another example, when an income transaction occurs, but the transaction is unsettled, the future balance will be increased by the predicted change of the transaction. Once the transaction settles, the predicted income is realized as actual income.

Forecasted account changes are expected account changes based on patterns. The system can determine, for example, that more obligations are created Fridays and forecast the need for additional funds in a particular account on that day, for example, as people spend their paychecks, creating obligations to merchants. As another example, statistical forecasts can be made that Tuesdays in October see a certain volume for a particular type of account activity. As another example, an upcoming event such as Singles day in Singapore, the World Cup in England, or the like, can cause a need for a larger than normal amount of cash in that country on a particular day. Forecasting can incorporate the expected future balance for monies needed in those countries. Forecasting can also show that the movement of money for that future event may happen over several days. For example, if a significant amount of money is moved in one day, the value of money in that currency may be impacted. Thus, sweeps can be spaced out over several days and the forecasting can show the future expected balances which illustrate the impact of those expected future transactions. As another example, forecasting can be used to determine expected future balances based on a trend that additional income is provided to one or more accounts on Mondays as credit issuers settle transactions occurring over the weekend.

There is likely overlap between predicted account changes and forecasted account changes, thus the expected future balances may be determined by utilizing the current balance and a blend of the predicted account changes and forecasted account changes. For example, some of the forecasted account changes may become predicted account changes when a transaction according to the forecasting is undertaken, but not yet settled. Thus, the expected future balance can be a blend of the predicted account changes and forecasted account changes. In some implementations, at the beginning of a particular time period the expected future balances may include 100% of the forecasted account changes for that time period. As more of the time period elapses, then less of the forecasted account changes for the time period may be included in the expected future balances. For example, when 50% of the time period has elapsed, then 50% of the forecasted account changes can be included. The inclusion of the forecasted account changes can be weighted to favor or disfavor inclusion early in the time period and remove the forecasted account changes later in the time period. For example, inclusion can be favored early in the time period by included a percentage of forecasted account changes linearly from 100% to 80% for the first half of the time period, and then move to a parabolic or exponential scale from 80% to 0% for the second half of the time period. Any combination of linear weighting or parabolic weighting for the inclusion of the forecasted account changes can be included over the course of a given time period.

The sweeps section can be expanded using the expansion indicator 346 to provide detail for automated sweeps scheduled by the automatic sweeps system and manual sweeps entered by a user. The settlements section can be expanded using the expansion indicator 346 to show detail for forecasted settlements and predicted settlements sections. The predicted settlements section can be expanded using the expansion indicator 346 to show detail for the sources section (e.g., Sources 1 and 2) for the predicted settlements section, such as an aggregate of all approved but unsettled transactions to be paid out by, e.g., a partner bank (Source 1) or, e.g., a card issuer (Source 2).

The balances provided in the cash positions section and in the pivot table 328 can be updated in real-time or at intervals. As noted above, the expected EOD 352 balance includes the current balance plus or minus the predicted cash sweeps plus or minus the forecasted cash sweeps and/or forecasted cash position changes. Over the course of the day the expected balance can be further refined and updated as the forecasted cash sweeps turn into predicted cash sweeps when sweeps which are forecasted are initiated but remain unsettled. The expected EOD 352 balance can be further refined as the predicted cash sweeps transition to realized transactions upon settlement. Thus, as the day goes on the expected EOD 352 becomes more accurate to what the actual EOD 352 will be. Alerts can be triggered, however, when discrepancies above or below a threshold occur in the expected EOD 352 occurs as compared to the actual balance. When the discrepancy exceeds a threshold, this anomaly could indicate a settlement issue or another liquidity problem. The threshold can be adjusted based on the remaining time of the day. For example, the threshold can start out higher at the beginning of the day and adjust downward as a percentage of the day goes by.

Thus, the user interface 300 provides account information that can be organized in a customized manner by the user to show accounts under various entities, under particular organization types within the entities, under various currencies, under various countries, and so forth. Historic, current, and future balances can be displayed in both individualized and aggregated forms. Details for each account can further be displayed to include an expected end-of-day balance and intraday information that includes cash sweep information for predicted and forecast cash moves. Contextual information provided by way of alert and information indicators can be displayed to provide interactive information for users to obtain more information or provide manual inputs, approvals, and/or overrides to automatically generated cash sweeps.

FIG. 4 illustrates an example user interface 400 for displaying and managing sweeps and sweeps alerts, in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The account management server 106 may generate and/or provide a user interface, such as the user interface 400, for displaying the sweeps and alerts related to the sweeps. The user interface 400, for example, can be utilized by administrative users to enter manual sweeps, view automatic sweeps, and view automatic sweeps requiring approval. The user interface 400 can further provide information on the underlying conditions or rules that were utilized in scheduling an automatic sweep. Sweeps can be shown as being scheduled or completed. Contextual alerts and information indicators can be provided to the administrative user to provide additional contextual information regarding the sweeps, accounts, or anomalies related to a particular sweep or account.

The user interface 400 may be interactive, minimizing the need for coding or technical expertise. The user interface 400 may be graphical, providing users with a visual canvas where they can interact with and manage account information using a variety of graphical elements (e.g., buttons, checkboxes, dropdowns, icons, pop-outs, input fields, breadcrumbs, etc.). The user interface 400 offers a centralized location for administrative users to view, edit, or engage in cash sweeps. The centralized nature of the subject technology and interface thereto may reduce the number of requests that a merchant needs to send to the server to manage the cash sweeps, thereby reducing the processing, memory, and/or communication resources needed to manage such cash sweeps.

The user interface 400 provides a type column 405, a sweep ID 410, a plan 415, a scheduled time 420, a source account 425, a destination account 430, an amount 435, and a currency 440. The type column 405 specifying a type of cash sweep in this example may be an automatic cash sweep, for example initiated by the automatic sweeps system, or a manually entered cash sweep. Some implementations may have an automatic cash sweep which is subject to user approval. Each sweep entry can have a unique sweep ID 410, such as SW11, SW21, SW31, SW41, SW51, or other unique identifier. Upon selection of each sweep, the sweep ID 410 can be used to pull and provide further detail to the user regarding the sweep transaction. For example, the further detail can include the rationale, such as the conditions or other details, which triggered the automatic sweep. For example, the destination account can be illustrated as having a projected shortfall and the source account(s) can be illustrated as having excess funds, available funds, or future expected excess or available funds. An estimated time to completion can also be illustrated to provide the administrative user with additional detail on the predicted settlement for the cash sweep transaction.

The plan 415 for each sweep can correspond to a pre-configured set of conditions, such as upper and lower bound thresholds which can trigger an automatic sweep. The entry for the plan 415 can include an indication of risk associated with the plan. For example, some plans will trigger in more risky situations (i.e., under a riskier set of pre-configured conditions). The illustrated user interface 400, for example, provides plans PID1, PID2, MID5, PID9, and MPID7. These may be unique plan identifiers for each sweep or may be a reusable identifier that identifies the pre-configured conditions. Here, PID1, PID2, and PID9 may reference “plan identifier 1,” “plan identifier 2,” and “plan identifier 9.” MID5 may reference “manual sweep plan identifier 5. MPID7 may reference a “plan identifier 7 requiring manual approval.” The scheduled time 420 can correspond to when the cash sweep is scheduled to occur, settle, or both. The source account 425 and destination account 430 respectively indicate which source account has funds removed to which destination account. The amount 435 indicates an amount that is moved or is being moved from the source account 425 to the destination account 430. The currency 440 indicates the native currency of the source funds moved.

Upon selection, the user can delete or modify a cash sweep entry. A button can be displayed which, when selected, allows a user to enter a manual cash sweep entry. For cash sweeps that have occurred already, a button can be displayed which, when selected, allows a user to enter a manual cash sweep entry that reverses the action.

Alert indicators, e.g., alert indicator 340, or information indicators can be displayed, such as illustrated in the user interface 300 for alerting the user to an alert condition involving e.g., a cash sweep, a source account 425, or a destination account 430. Alerts can also be generated and provided for entity and/or category contexts. Alerts can also be generated and provided to the user based on an indication of anomalous conditions received from other functions of the system. For example, if the cash flow management service observes an anomaly, the account management server can receive an indication from the cash flow management service and provide an alert to the user based on information received by the account management server from the cash flow management service. As another example, if a foreign currency management system observes an anomaly, the account management server can receive an indication from the foreign currency management system and provide an alert to the user based on information received by the account management server from the foreign currency management system. The alert can provide the user with relevant contextual information particular to the source of the anomaly that triggered the alert.

Thus, the cash sweeps interface allows the administrative user to interact with the cash sweeps which have been completed and/or which have settled. Each of the cash sweeps in the list can be interacted with to obtain additional detail regarding the cash sweep. Alerts for anomalies and/or information can be provided via contextual indicators so that when users select an indicator they are provided with additional information via the user interface 400 related to the indicator selected.

FIG. 5 illustrates an example interface 500 for displaying and managing FX positions, in accordance with one or more embodiments. Not all depicted components may be used in all embodiments, however, and one or more embodiments may include additional or different components than those shown in the figure. Variations in the arrangement and type of the components may be made without departing from the spirit or scope of the claims as set forth herein. Additional components, different components, or fewer components may be provided.

The account management server 106 may generate and/or provide a user interface, such as the user interface 500, for displaying the FX positions. The user interface 500 can display information related to foreign currency positions. For example, when a hedge position is taken, the user interface 500 can provide information on the hedge positions for each currency relative to a base currency, such as US dollars. The user interface 500 provides signal information such as volume indicators, which can be compared to a banded threshold (high threshold and low threshold) so that when the signal falls outside the band, then alerts can be triggered and an alert indicator displayed on the user interface 500. Further, automatic trading can be toggled on or off, depending on the type of trigger that is made. The historical position of the position of the foreign currencies can be displayed over a specified time period. The user interface 500 enables users, therefore, to engage with the foreign currency positions so that hedged positions can be aggregated or offset internally, if better than executing FX trades. Further, the user interface 500 enables users to reduce or eliminate hedge positions when combined with predicted sweeps information.

The user interface 500 may be interactive, minimizing the need for coding or technical expertise. The user interface 500 may be graphical, providing users with a visual canvas where they can interact with and manage account information using a variety of graphical elements (e.g., buttons, checkboxes, dropdowns, icons, pop-outs, input fields, breadcrumbs, etc.). The user interface 500 offers a centralized location for administrative users to view, edit, or engage in foreign currency exchange related monitoring and task management. The centralized nature of the subject technology and interface thereto may reduce the number of requests that a merchant needs to send to the server to manage the FX positions, thereby reducing the processing, memory, and/or communication resources needed to manage such FX positions.

The user interface 500 provides a time period input 505, a currency listing 510 for a currency pair, the balance in the local currency 515, the balance in the nominal currency 520, e.g., USD, a performance graph 525 over the time period for each of the foreign currency pairs, a high balance 530 over the time period, a low balance 535 over the time period, and an indicator 540 of whether automatic trading is enabled on the currency pair. The currency listing 510 for a currency pair is displayed as the foreign currency for the currency value pair Foreign/Base, where Base is the nominal currency. In this example, the nominal currency is USD, but it should be appreciated that the nominal currency may be any currency. Because the nominal currency is USD, then auto trading does not apply for a USD/USD currency pair.

The user interface 500 may also supply additional information and allow the user to set trading or warning thresholds. Signals can be provided based on the thresholds. One signal can be set, for example, on user volume in the last hour for each of the currency pairs. Another signal can be displayed based on trading volume in the last 24 hours. In addition to signals, the user interface 500 may also provide a listing of how much money is outstanding with trade partners. The user interface 500 may also provide the ability to download raw data for use, for example, with other applications.

The thresholds and signals can be used to automatically disable auto trading if the threshold condition is triggered. For example, if the amount of Australian dollars is higher than a hard max, automatic trading can automatically be triggered to be turned off. An alert can also be triggered to indicate to a user that the condition needs to be looked into and cleared or handled. The thresholds can create upper and lower limits so that the system ideally operates within a set band. If a volume signal goes above a threshold, then automatic trading can be turned off. If a volume signal goes below a threshold, then automatic trading can be left on, but an alert can be triggered to the user to investigate. Thus, the user interface 500 can also provide users with visibility on when trades are prohibited, for example, if trade volume is too high.

The user interface 500 may also supply information pertaining to the buys, the sales for the user, the net, the net of that trade's buys, sales, and so forth. When a transaction is initiated, the system can initiate a hedge automatically against the transaction to insulate the transaction against fluctuations in the FX market. Utilizing the aspects of the treasury tools as described herein, the hedge positions can be adjusted based on cross-account information. The user interface 500 may also supply information regarding how trades are internalized or netted so that user buys and sells may offset one another. This provides the ability to reassign a hedge position from one transaction to another without closing the hedge. This also provides the ability to close or reduce a hedge position prior to a transaction on which the hedge was taken fully settles. For example, after settling a first transaction, an existing hedge from the first transaction can be reassigned to a second transaction which has a second hedge. For example, when the existing hedge has better terms than the second hedge it may be preferable to maintain the existing hedge and reduce or eliminate the second hedge.

In another example, the predicted and/or forecast balances can be used to alter the hedge positions. Rather than maintain hedge positions on a per transaction basis, hedge positions can be maintained based on predicted and/or forecast positions. Thus, a hedge can be taken based on a transaction, then that same hedge can be reduced or eliminated based on predicted and/or forecast positions. For example, before the transaction settles, the settlement can be predicted based on historical settlement trends with that banking partner. As the predicted settlement time approaches, the probability of fluctuation in the FX currency pair diminishes. Thus, the hedge position can be reduced or eliminated. In another example, a balance is forecasted based on a combination of predicted and forecast data. Individual transactions may cause a blend between forecast balance and predicted balance to shift from being heavier forecast to heavier predicted. As the end of day approaches, if the expected end of day balance for a particular currency is on track to be realized, then the hedge position for that currency can be reduced or eliminated to correspond to the expected end of day balance.

Upon selection of an FX position, detailed information can be displayed for that position and the user can modify the position taken with respect to that currency pair manually. A button can be displayed which, when selected, allows a user to enter a manual FX trade.

Alert indicators, e.g., alert indicator 340, or information indicators can be displayed, such as illustrated in the user interface 300 for alerting the user to an alert condition involving e.g., a FX threshold condition, a hedge position, and so forth.

Thus, the user interface 500 can display information related to foreign currency positions, thereby enabling administrative users to view historic and current FX positions and utilize tools to manage hedge positions for various currencies. Balances and signals can be monitored automatically to generate alerts or information for anomalous behavior and/or manage automatic trading.

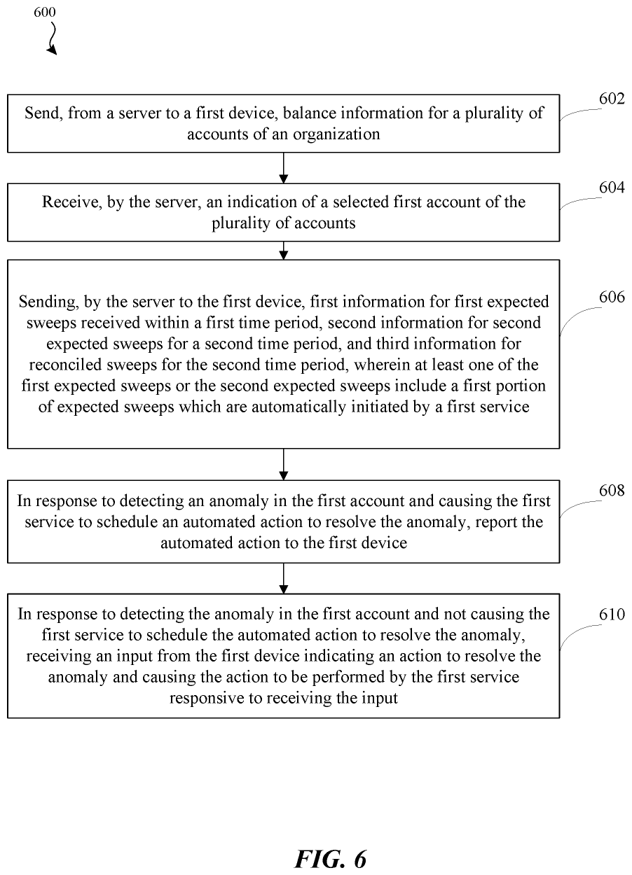

FIG. 6 illustrates a flow diagram of an example process 600 for alerting a user when an anomaly is detected in expected sweeps, in accordance with one or more embodiments. For explanatory purposes, the process 600 is primarily described herein with reference to the electronic device 102 and the account management server 106 of FIG. 1. However, the process 600 is not limited to the electronic device 102 and the account management server 106, and one or more blocks of the process 600 may be performed by one or more other by other suitable devices. Further, for explanatory purposes, the blocks of the process 600 are described herein as occurring sequentially or linearly. However, multiple blocks of the process 600 may occur in parallel. In addition, the blocks of the process 600 need not be performed in the order shown and/or one or more blocks of the process 600 need not be performed and/or can be replaced by other operations.

Processes associated with the flow diagram of FIG. 6 relate to the management of cash sweeps, as described above with respect to FIGS. 3 and 4. As noted above, a current balance and expected end of day balance and expected intraday balances are provided for an account at the user interface 300. These balances are based, at least in part, on the expected cash sweeps for the account. When an anomaly is detected between the expected cash sweeps which are expected within a first time period, e.g., by the end of the day, or the expected cash sweeps within a second time period, e.g., at an intraday time, and the reconciled sweeps within the second time period, then an action can be taken. The action can be an automated event, e.g., another cash sweep scheduled. The action may be to alert the administrative user about the anomaly and provide a suggested action. At block 602, an account management server (e.g., the account management server 106) may provide to an electronic device (e.g., the electronic device 102), balance information for a plurality of accounts, such as financial accounts, of an organization. The balance information can include information such as that depicted in the user interface 300 of FIG. 3 and discussed above. The electronic device may, for example, display the balance information to a user, such as via the user interface 300 discussed above with respect to FIG. 3. At block 604, the account management server can receive, from the electronic device, an indication of a selected first account of the plurality of accounts. For example, the user may select the expansion indicator 346 of the user interface 300 next to the first account which is selected from a plurality of accounts, as discussed above with respect to FIG. 3. Thus, the user may select an account for receiving additional information. The account management server can receive this indication and provide additional information to the electronic device, as outlined in the next block.

At block 606, the account management server can send to the electronic device, information for first expected sweeps which are to be received within a first time period, such as by an end of day, information for second expected sweeps for a second time period, such as for a specified intraday time, and information for reconciled sweeps for the second time period, such as for the specified intraday time. This information can be provided, for example, by the user interface 300 under the sweeps heading, as descripted above with respect to FIG. 3 and/or by the user interface 400, as described above with respect to FIG. 4. At least one of the first expected sweeps or the second expected sweeps can include a first portion of expected sweeps which are automatically initiated by another service, such as a cash flow management service. This can include, for example, transactions automatically initiated by the automatic sweeps system.

As an example, an account may need to have a certain balance at a certain time, for example to cover an expected future settlement of a transaction at that time or to cover expected expenditures at that time. An automated transaction can be scheduled to occur to meet that balance obligation. The transaction time can be set based on an expected settlement time between one or more source accounts and the destination account. If the expected settlement time is missed, then an anomaly can be determined by the account management server or by the cash flow management service and reported to the account management server.

At block 608, in response to detecting an anomaly in the selected account and in response to causing the cash flow management service to schedule an automated action to resolve the anomaly, the automated event is reported to the electronic device. In some implementations, the account management server can detect the anomaly and cause the cash flow management service to schedule an action, such as an automated transaction from one account to another, to resolve the anomaly. In some implementations, the cash flow management service can detect the anomaly and automatically schedule the automated transaction and report the anomaly and automated action to the account management server. The reporting of the automatic action to the electronic device can be provided, for example, by way of the alert indicator 340 and/or information indicator 342, as described above with respect to the user interface 300 of FIG. 3. For example, if the reconciled intraday balance is lower than the expected intraday balance, a precautionary cash sweep can be automatically scheduled by an automatic sweeps system or can be caused by the account management system to be scheduled using the automatic sweeps system.

This automated event can be reported to the electronic device, for example, by including it in an updated expected end of day or updated intraday balance, or by including it in a cash sweeps detail page. In some implementations an alert can also be triggered.

Continuing with the above example, if the cash flow management service can resolve the anomaly by scheduling another transfer from another account that would meet the shortfall by the time it's needed, then it can automatically schedule the action, i.e., the transfer, to resolve the anomaly. A notification can be generated and provided to the user, for example, by the user accessing the user interface 400.

At block 610, in response to detecting an anomaly in the selected account and in response to not causing the cash flow management service to schedule an automated action to resolve the anomaly, an input can be received from the electronic device indicating an action to resolve the anomaly. In some implementations, the account management server can detect the anomaly and may not be able to cause the cash flow management service to schedule an action. In some implementations, the cash flow management service can detect the anomaly and may not be able to automatically schedule an automated action to resolve the anomaly. In such implementations, the system can send a prompt to the electronic device for an action to resolve the anomaly. This prompt can be provided, for example, by way of the alert indicator 340 and/or information indicator 342, as described above with respect to the user interface 300 of FIG. 3. When selected, the system can display a suggested action to resolve the anomaly and provide an input to execute the action. Upon receiving the input, the action can be caused to be performed, for example by the other service, such as by a cash flow management service. If, for example, for some reason, the automatic sweeps system cannot schedule a transaction to resolve the anomaly or the automatic sweeps system cannot be caused to schedule a transaction to resolve the anomaly, then the electronic device can be alerted, for example, by providing an alert indicator on the user interface 300. The user can select the alert indicator and be provided with a description of the issue. The user can then initiate an action to resolve the issue. In some implementations, the user can be provided with a suggested cash sweep which requires user approval, and the indication of the action can be the approval from the user. For example, if the automatic sweeps system needs to schedule a cash sweep from one entity to another entity, then this might require user approval. Or, if the automatic sweeps system needs to schedule a cash sweep from two or more accounts to another account, then this might require user approval.

Continuing again with the above example, if the cash flow management service cannot resolve the anomaly by scheduling another transfer from another account that would meet the shortfall by the time the money is needed, for example, because there are not enough funds available in source accounts with a short enough expected settlement time to meet the shortfall by the time the money is needed, then an alert can be provided to notify the user that the anomaly could not be automatically addressed. Then, the user can address the alert and resolve the anomaly manually, such as via a user interface provided by the subject system. In some implementations, the cash flow management service can automatically schedule a next best transfer or other resolution which would meet one or more conditions, but not necessarily all conditions required. For example, if the money could be on time, but not enough money could be provided from one or more source accounts, then next-best transaction(s) can be scheduled subject to approval by the user which would better position the destination account. If enough money can be provided from one or more other sources, but settlement would be beyond the time the money is needed in the destination account, then one or more transactions can be settled subject to approval by the user which would better position the destination account. The user can view these proposed actions and adjust them and/or approve them as appropriate.

In some implementations, the expected sweeps include a blend of predicted sweeps which are unsettled transactions and forecasted sweeps which are determined by the cash flow management service based on trend data. As noted above, an expected future balance can be determined based on predicted transactions, which are settlements of transactions that are not yet settled, and forecasted cash flow. Forecasted cash flow uses trend data to determine expected movement. A blend of the predicted transactions and the forecasted cash flow is used to determine the expected balance. In a similar manner cash sweeps can also be predicted and forecasted to affect the expected future balance. Some cash sweeps may be initiated and then a delay occurs between the transaction of the cash sweep and the settlement of the cash sweep. This can be included in a predicted cash sweep. For forecasted cash sweeps, an account may have historical data associated with it that indicate particular trends in cash sweeps. These trends can be used to determine an expected future cash sweep (a forecasted cash sweep).

In some implementations, a machine learning model can be used to analyze the historical trend data for cash sweeps and balances and provide the forecasts as an output of the machine learning model. For example, the machine learning model can be trained on actual balance data and cash sweep data. A k-means clustering algorithm can be used to cluster data on a per date basis, a per day of week basis, per week of month basis, per month of year basis, or combinations thereof.

In some implementations, the forecasted settlement data can be used to initiate a cash sweep days in advance of an event. For example, if a forecasted balance in a foreign country is well above the current balance in that country in three days, then cash sweeps can automatically be initiated by the automatic sweeps system to accommodate the anticipated needed balance in that country in three days. It can start moving the money days in advance because, the settlement times might be long, the ability to exchange into the appropriate currency may be limited, or a combination of the two. Similarly, settlement delays in other countries can be utilized to schedule cash sweeps so that capital arrives when it is needed. This helps maximize capital usage by allowing planning ahead, but eliminating the need to sweep excess funds into higher risk accounts.

In some implementations, the account management server can initiate a cash sweep that requires manual approval by taking into account an estimated time to obtain the manual approval and an estimated time it takes to settle the cash sweep. Thus, the account management server can initiate the cash sweep in advance by offsetting the time needed to obtain approval of the sweep.

In some implementations, the account management server can receive an indication that a financial account would fail to meet a first threshold or would exceed a second threshold. The threshold may be related to an expected balance or may be related to an expected sweeps for the financial account. In such instances, the account management server can trigger an alert. The threshold may be related to a balance condition, a delayed settlement, a failed cash sweeps transaction, and so forth. The alert can be provided to the electronic device in the context of the account. For example, the alert can cause the electronic device to display an alert indicator next to the account in question. Further, selecting the alert can cause a display box to provide contextual information for the alert near the account in question. A link or prompt can be provided to the user for the user to send instructions to the account management server for rectifying or dismissing the alert. The prompt can include, for example, a proposed cash sweep for approval by a user of the electronic device.

In some implementations, the alert can include information to the electronic device that the cash flow management service has initiated a transfer so that the financial account would meet the first threshold or the second threshold by the end of the day. In such embodiments, the account management server can provide to the electronic device, a list of one or more transactions for the expected sweeps. The user may select one of the transactions in the list of transactions and the account management server can provide to the electronic device a rationale behind the transaction. For example, the cash management service may initiate a transfer based on an expected deficiency in a destination account and indicate the selection of a source account was based on an excess balance in the source account, a settlement time between the source account and the destination account, or other rationale. In some implementations, the list of transactions may indicate completed sweeps and scheduled or unsettled sweeps.

In some implementations, sweeps may be automatically scheduled because of rationale that can include regulatory considerations, liquidity considerations, transaction delay considerations, threshold considerations, emergency controls considerations, settlement considerations, calendar event considerations, interest bearing considerations, fee reducing considerations, or combinations thereof.

In some implementations, the account management server can determine a problem with a transaction partner and pause all sweeps with the transaction partner. For example, if a bank itself has liquidity issues and an account at the bank has liquidity issues, rather than feed the account and the bank with capital, only to lose that capital in the case of bank failure, an emergency control can be implemented which stops performing cash sweeps with the transaction partner. An emergency alert, for example, which pauses trading activity could arise, for example, when a transaction which was expected to settle settles for less than the amount expected, is delayed, or fails altogether, which may indicate a liquidity issue with the transaction partner. Thus, activity with the transaction partner that would cause money to be transferred to that transaction partner can be paused until the status of that partner can be verified. For example, if a bank was beginning to fail to meet its obligations, one would not want to provide more money to the bank that could be lost in the case of a bank failure. The emergency alert can also cause a notification to account managers by text message, email, or another communication system. An information indicator or alert indicator, such as the information indicator 342 or alert indicator 340 of the user interface 300, can be used to inform the user of the condition.

FIG. 7 illustrates a flow diagram of an example process 700 for managing a hedge position in a foreign exchange (FX) system, in accordance with one or more embodiments. For explanatory purposes, the process 700 is primarily described herein with reference to the electronic device 102 and the account management server 106 of FIG. 1. However, the process 700 is not limited to the electronic device 102 and the account management server 106, and one or more blocks of the process 700 may be performed by one or more other by other suitable devices. Further, for explanatory purposes, the blocks of the process 700 are described herein as occurring sequentially or linearly. However, multiple blocks of the process 700 may occur in parallel. In addition, the blocks of the process 700 need not be performed in the order shown and/or one or more blocks of the process 700 need not be performed and/or can be replaced by other operations.

Processes associated with the flow diagram of FIG. 7 relate to the management of foreign currencies and foreign currency transactions, as described above with respect to the user interface 500 of FIG. 5. As noted above, foreign currency positions can be provided via the user interface 500. These positions are based, at least in part, on automated hedge positions taken with respect to a transaction or cash sweep between currencies. Processes associated with this provide the ability to reduce a hedge position prior to settlement of the cash sweep, as described below. Further, processes, associated with this interface can trigger a pause on automated trading when a signal threshold is exceeded. At block 702, an account management server (e.g., the account management server 106) may provide to an electronic device (e.g., the electronic device 102), position information for one or more foreign currencies. This can be provided, for example, by the user interface 500 of FIG. 5. The position information may include an indication of historical position over a time window, such as illustrated by the performance graph 525, high balance 530, and/or low balance 535. The position information can also include a first foreign currency position based on an automatically executed currency trade to enter a hedge position for the first foreign currency position based on a transaction in the foreign currency.

At block 704, the account management server can enable a cash flow management service to automatically execute a trade to reduce or eliminate the hedge position after a settlement for the transaction is predicted and before the settlement for the transaction is completed. As noted above, because the settlement can be predicted, the risk for the transaction can be reduced or eliminated prior to the settlement actually occurring.

At block 706, when the foreign currency includes a trade volume that exceeds a threshold, the account management server can disable the cash flow management service from automatically trading the foreign currency. The account management server can also trigger an alert and provide an indication of the alert to the electronic device to indicate that a trade cannot be automatically completed.

In some implementations, the account management server can provide graph information for display at the electronic device, where the graph information depicts the position information over the duration of the time window. The time window can be selected by a user of the electronic device and received by the account management server as an option from the electronic device. The time window can be selected from a plurality of pre-defined timeframes, such as a 24-hour window, a 3-day window, a 7-day window, a two-week window, a month window, the like, or combinations thereof.

In some implementations, such as depicted in user interface 500, an indication can be provided from the account management server to the electronic device to be displayed by the electronic device that indicates whether automatic trading is enabled for each of the foreign currencies of the one or more foreign currencies. Further aggregated buy and sell transactions for each of the foreign currencies can be provided by the account management server to the electronic device. The aggregated buy and sell transactions can be provided for the time window. The electronic device can display the aggregated transaction data.

Some implementations may include a method, the method including providing, from a first device such as a server to a second device such as a client, position information for one or more foreign currencies, where the position information includes an indication of historical position over a time window, and where the position information includes a first foreign currency position based on an automatically executed currency trade to enter a hedge position for the first foreign currency position based on a transaction in the foreign currency. A cash flow management service may be enabled to automatically execute a trade to reduce or eliminate the hedge position after a settlement for the transaction is predicted and before the settlement for the transaction is completed. When the foreign currency includes a trade volume that exceeds a threshold, the cash flow management service may be disabled from automatically trading the foreign currency. Also, an alert may be triggered to indicate that a trade cannot be automatically completed.

In some implementations, graph information may be provided from the first device to the second device based on the position information over the time window. In some implementations the time window is received by the first device from the second device from a plurality of pre-defined timeframes. In still some implementations, an indication may be provided from the first device to the second device, the indication to be displayed by the second device indicating whether automatic trading is enabled for each of the foreign currencies of the one or more foreign currencies. In some implementations, trading signals may be provided from the first device to the second device, the trading signals to be displayed by the second device for automatic trading for each of the foreign currencies of the one or more foreign currencies. In still some embodiments, aggregated buy and sell transactions may be provided from the first device to the second device, the aggregated buy and sell transactions to be displayed by the second device for each of the foreign currencies of the one or more foreign currencies which are aggregated over the time window.

FIG. 8 depicts an example electronic system 800 with which aspects of the present disclosure may be implemented, in accordance with one or more embodiments. The electronic system 800 can be, and/or can be a part of, any electronic device for generating the features and processes described in reference to FIGS. 1-7, including but not limited to a laptop computer, tablet computer, smartphone, and wearable device (e.g., smartwatch, fitness band). The electronic system 800 may include various types of computer-readable media and interfaces for various other types of computer-readable media. The electronic system 800 includes one or more processing unit(s) 814, a persistent storage device 802, a system memory 804 (and/or buffer), an input device interface 806, an output device interface 808, a bus 810, a ROM 812, one or more processing unit(s) 814, one or more network interface(s) 816, and/or subsets and variations thereof.

The bus 810 collectively represents all system, peripheral, and chipset buses that communicatively connect the numerous internal devices of the electronic system 800. In one or more embodiments, the bus 810 communicatively connects the one or more processing unit(s) 814 with the ROM 812, the system memory 804, and the persistent storage device 802. From these various memory units, the one or more processing unit(s) 814 retrieves instructions to execute and data to process in order to execute the processes of the subject disclosure. The one or more processing unit(s) 814 can be a single processor or a multi-core processor in different embodiments.

The ROM 812 stores static data and instructions that are needed by the one or more processing unit(s) 814 and other modules of the electronic system 800. The persistent storage device 802, on the other hand, may be a read-and-write memory device. The persistent storage device 802 may be a non-volatile memory unit that stores instructions and data even when the electronic system 800 is off. In one or more embodiments, a mass-storage device (such as a magnetic or optical disk and its corresponding disk drive) may be used as the persistent storage device 802.

In one or more embodiments, a removable storage device (such as a floppy disk, flash drive, and its corresponding disk drive) may be used as the persistent storage device 802. Like the persistent storage device 802, the system memory 804 may be a read-and-write memory device. However, unlike the persistent storage device 802, the system memory 804 may be a volatile read-and-write memory, such as RAM. The system memory 804 may store any of the instructions and data that one or more processing unit(s) 814 may need at runtime. In one or more embodiments, the processes of the subject disclosure are stored in the system memory 804, the persistent storage device 802, and/or the ROM 812. From these various memory units, the one or more processing unit(s) 814 retrieves instructions to execute and data to process in order to execute the processes of one or more embodiments.

The bus 810 also connects to the input device interfaces 806 and output device interfaces 808. The input device interface 806 enables a user to communicate information and select commands to the electronic system 800. Input devices that may be used with the input device interface 806 may include, for example, alphanumeric keyboards, touch screens, and pointing devices. The output device interface 808 may enable the electronic system 800 to communicate information to users. For example, the output device interface 808 may provide the display of images generated by electronic system 800. Output devices that may be used with the output device interface 808 may include, for example, printers and display devices, such as a liquid crystal display (LCD), a light emitting diode (LED) display, an organic light emitting diode (OLED) display, a flexible display, a flat panel display, a solid-state display, a projector, or any other device for outputting information. One or more embodiments may include devices that function as both input and output devices, such as a touchscreen. In these embodiments, feedback provided to the user can be any form of sensory feedback, such as visual feedback, auditory feedback, or tactile feedback; and input from the user can be received in any form, including acoustic, speech, or tactile input.

The bus 810 also couples the electronic system 800 to one or more networks and/or to one or more network nodes through the one or more network interface(s) 816. In this manner, the electronic system 800 can be a part of a network of computers (such as a local area network, a wide area network, an intranet, or a network of networks, such as the internet). Any or all components of the electronic system 800 can be used in conjunction with the subject disclosure.

Embodiments within the scope of the present disclosure can be partially or entirely realized using a tangible computer-readable storage medium (or multiple tangible computer-readable storage media of one or more types) encoding one or more computer-readable instructions. The tangible computer-readable storage medium also can be non-transitory in nature.

The computer-readable storage medium can be any storage medium that can be read, written, or otherwise accessed by a general purpose or special purpose computing device, including any processing electronics and/or processing circuitry capable of executing instructions. For example, without limitation, the computer-readable medium can include any volatile semiconductor memory, such as RAM, DRAM, SRAM, T-RAM, Z-RAM, and TTRAM. The computer-readable medium also can include any non-volatile semiconductor memory, such as ROM, PROM, EPROM, EEPROM, NVRAM, flash, nvSRAM, FeRAM, FeTRAM, MRAM, PRAM, CBRAM, SONOS, RRAM, NRAM, racetrack memory, FJG, and Millipede memory.

Further, the computer-readable storage medium can include any non-semiconductor memory, such as optical disk storage, magnetic disk storage, magnetic tape, other magnetic storage devices, or any other medium capable of storing one or more instructions. In one or more embodiments, the tangible computer-readable storage medium can be directly coupled to a computing device, while in other embodiments, the tangible computer-readable storage medium can be indirectly coupled to a computing device, e.g., via one or more wired connections, one or more wireless connections, or any combination thereof.

Instructions can be directly executable or can be used to develop executable instructions. For example, instructions can be realized as executable or non-executable machine code or as instructions in a high-level language that can be compiled to produce executable or non-executable machine code. Further, instructions also can be realized as or can include data. Computer-executable instructions also can be organized in any format, including routines, subroutines, programs, data structures, objects, modules, applications, applets, functions, etc. As recognized by those of skill in the art, details including, but not limited to, the number, structure, sequence, and organization of instructions can vary significantly without varying the underlying logic, function, processing, and output.

While the above discussion primarily refers to microprocessors or multi-core processors that execute software, one or more embodiments are performed by one or more integrated circuits, such as ASICs or FPGAs. In one or more embodiments, such integrated circuits execute instructions that are stored on the circuit itself.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way), all without departing from the scope of the subject technology.

It is understood that any specific order or hierarchy of blocks in the processes disclosed is an illustration of example approaches. Based upon design preferences, it is understood that the specific order or hierarchy of blocks in the processes may be re-arranged, or that all illustrated blocks be performed. Any of the blocks may be performed simultaneously. In one or more embodiments, multitasking and parallel processing may be advantageous. Moreover, the separation of various system components in the embodiments described above should not be understood as requiring such separation in all embodiments, and it should be understood that the described program components and systems can generally be integrated together into a single software product or packaged into multiple software products.

As used in this specification and any claims of this application, the terms “base station,” “receiver,” “computer,” “server,” “processor,” and “memory” all refer to electronic or other technological devices. These terms exclude people or groups of people. For the purposes of the specification, the terms “display” or “displaying” means displaying on an electronic device.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refers to only A, only B, or only C; any combination of A, B, and C; and/or at least one of each of A, B, and C.

The predicate words “configured to,” “operable to,” and “programmed to” do not imply any particular tangible or intangible modification of a subject, but, rather, are intended to be used interchangeably. In one or more embodiments, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, one or more implementations, an embodiment, the embodiment, another embodiment, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration.” Any embodiment described herein as “exemplary” or as an “example” is not necessarily to be construed as preferred or advantageous over other embodiments. Furthermore, to the extent that the term “include,” “have,” or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for.”

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein but are to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. A method comprising:
sending, from a server to a first device, balance information for a plurality of accounts of an organization;
receiving, by the server, an indication of a selection of a first account of the plurality of accounts;
sending, from the server to the first device, first information for first expected sweeps received within a first time period, second information for second expected sweeps for a second time period, and third information for reconciled sweeps for the second time period, wherein at least one of the first expected sweeps or the second expected sweeps include a first portion of expected sweeps which are automatically initiated by a first service;
in response to detecting an anomaly in the first account and causing the first service to schedule an automated action to resolve the anomaly, reporting the automated action to the first device; and
in response to detecting the anomaly in the first account and not causing the first service to schedule the automated action to resolve the anomaly, receiving an input from the first device indicating an action to resolve the anomaly and causing the action to be performed by the first service responsive to receiving the input.

2. The method of claim 1, wherein the expected sweeps include a blend of predicted sweeps which are unsettled transactions and forecasted sweeps which are determined by the first service based on trend data.

3. The method of claim 2, wherein the forecasted sweeps are generated at least in part by a machine learning model.

4. The method of claim 1, further comprising:
upon receiving an indication that a second account of the plurality of accounts fails to meet a first threshold or exceed a second threshold based on expected sweeps or an expected balance for the second account, triggering an alert.

5. The method of claim 4, further comprising:
sending, by the server, the alert with a context of the second account to the first device.

6. The method of claim 5, further comprising:
responsive to receiving an indication that the alert was selected by a user, providing contextual information for the alert and a prompt to receive instructions for rectifying or dismissing the alert.

7. The method of claim 5, further comprising:
responsive to receiving an indication that the alert was selected by a user, providing contextual information for the alert and information to the user indicating that the first service has initiated an action to satisfy the first threshold or the second threshold.

8. The method of claim 1, further comprising:
responsive to receiving an indication that the first expected sweeps is selected by a user, causing display of a list of one or more transactions for the expected sweeps; and
responsive to receiving an indication that a first transaction in the list of transactions is selected by a user, providing a rationale for the transaction.

9. The method of claim 8, wherein a first portion of the list of transactions indicates completed sweeps and a second portion of the list of transactions indicates scheduled or unsettled sweeps.

10. A system comprising:
a processor;
a memory device containing instructions, which when executed by the processor cause the processor to perform operations comprising:
sending, from a server to a first device, balance information for a plurality of accounts of an organization;
receiving, by the server, an indication of a selection of a first account of the plurality of accounts;
sending, from the server to the first device, first information for first expected sweeps received within a first time period, second information for second expected sweeps for a second time period, and third information for reconciled sweeps for the second time period, wherein at least one of the first expected sweeps or the second expected sweeps include a first portion of expected sweeps which are automatically initiated by a first service;
in response to detecting an anomaly in the first account and causing the first service to schedule an automated action to resolve the anomaly, reporting the automated action to the first device; and
in response to detecting the anomaly in the first account and not causing the first service to schedule the automated action to resolve the anomaly, receiving an input from the first device indicating an action to resolve the anomaly and causing the action to be performed by the first service responsive to receiving the input.

11. The system of claim 10, wherein the expected sweeps include a blend of predicted sweeps which are unsettled transactions and forecasted sweeps which are determined by the first service based on trend data.

12. The system of claim 11, wherein the forecasted sweeps are generated at least in part by a machine learning model.

13. The system of claim 10, wherein the operations further comprise:
upon receiving an indication that a second account of the plurality of accounts fails to meet a first threshold or exceed a second threshold based on expected sweeps or an expected balance for the second account, triggering an alert.

14. The system of claim 13, wherein the operations further comprise:
responsive to receiving an indication that the alert was selected by a user, providing contextual information for the alert and information to the user indicating that the first service has initiated an action to satisfy the first threshold or the second threshold or a prompt to receive instructions for rectifying or dismissing the alert.

15. The system of claim 10, wherein the operations further comprise:
responsive to receiving an indication that the first expected sweeps is selected by a user, causing display of a list of one or more transactions for the expected sweeps; and
responsive to receiving an indication that a first transaction in the list of transactions is selected by a user, providing a rationale for the transaction.

16. A non-transitory computer-readable medium comprising:
computer-readable instructions that, when executed by a processor, cause the processor to perform one or more operations comprising:
sending, from a server to a first device, balance information for a plurality of accounts of an organization;
receiving, by the server, an indication of a selection of a first account of the plurality of accounts;
sending, from the server to the first device, first information for first expected sweeps received within a first time period, second information for second expected sweeps for a second time period, and third information for reconciled sweeps for the second time period, wherein at least one of the first expected sweeps or the second expected sweeps include a first portion of expected sweeps which are automatically initiated by a first service;
in response to detecting an anomaly in the first account and causing the first service to schedule an automated action to resolve the anomaly, reporting the automated action to the first device; and
in response to detecting the anomaly in the first account and not causing the first service to schedule the automated action to resolve the anomaly, receiving an input from the first device indicating an action to resolve the anomaly and causing the action to be performed by the first service responsive to receiving the input.

17. The non-transitory computer-readable medium of claim 16, wherein the instructions cause the processor to further: upon receiving an indication that a second account of the plurality of accounts fails to meet a first threshold or exceed a second threshold based on expected sweeps or an expected balance for the second account, triggering an alert.

18. The non-transitory computer-readable medium of claim 17, wherein the instructions cause the processor to further: responsive to receiving an indication that the alert was selected by a user, providing contextual information for the alert and information to the user indicating that the first service has initiated an action to satisfy the first threshold or the second threshold or a prompt to receive instructions for rectifying or dismissing the alert.

19. The non-transitory computer-readable medium of claim 16, wherein the instructions cause the processor to further:
responsive to receiving an indication that the first expected sweeps is selected by a user, sending to the first device a list of one or more transactions for the expected sweeps; and
responsive to receiving an indication that a first transaction in the list of transactions is selected by a user, providing a rationale for the transaction.

20. The non-transitory computer-readable medium of claim 19, wherein a first portion of the list of transactions indicates completed sweeps and a second portion of the list of transactions indicates scheduled or unsettled sweeps.
